(19) United States
(12) Patent Application Publication
(10) Pub. No.: US 2006/0077795 A1
(43) Pub. Date: Apr. 13, 2006

(54) Objective optical system for optical recording media and optical pickup device using it

(75) Inventors: Yu Kitahara, Saitama City (JP); Toshiaki Katsuma, Tokyo (JP); Masao Mori, Saitama City (JP); Tetsuya Ori, Koshigaya City (JP)

Correspondence Address: ARNOLD INTERNATIONAL, P. O. BOX 129, GREAT FALLS, VA, 22066-0129, US

(73) Assignee: FUJINON CORPORATION

(21) Appl. No.: 11/213,682

(22) Filed: Aug. 30, 2005

(30) Foreign Application Priority Data
Sep. 1, 2004 (JP) 2004-254035

(51) Int. Cl. G11B 7/00

(52) U.S. Cl. 369/44.24; 369/44.25; 369/112.01

(57) ABSTRACT

An objective optical system for focusing light from a light source onto optical recording media includes an aperture control filter with a diffractive optical function formed as a glass plate with an aperture control structure on one side and a diffractive optical structure, such as a plastic diffractive optical element adhered to the glass plate on the other side, and an objective lens. The objective optical system focuses three light beams of three different wavelengths at three different numerical apertures onto desired positions of three different recording media with substrates of different thicknesses, such as a BD (or an AOD), a DVD, and a CD, that introduce different amounts of spherical aberration in the focused beams. The objective optical system provides compensating spherical aberration to the three light beams while keeping constant the distance between the aperture control filter with a diffractive optical function and the objective lens.

### TECHNICAL FIELD OF THE INVENTION

The present invention relates to an objective optical system for an optical recording medium that, when recording or reproducing information, efficiently focuses light of any one of three different wavelengths onto an appropriate corresponding recording medium according to standardized characteristics such as the numerical aperture of the objective optical system used, the wavelength of the light selected, and the substrate thickness of the optical recording medium. In addition, the present invention relates to an optical pickup device using such an objective optical system. More specifically, the present invention relates to an objective optical system for an optical recording medium wherein a diffractive optical element is used to diffract light in order to efficiently focus light of any one of the three wavelengths onto a corresponding one of the three optical recording media, and it also relates to an optical pickup device using such an objective optical system.

### BACKGROUND OF THE INVENTION

According to recent developments of optical recording systems, optical pickup devices that carry out recording and reproducing operations using two alternative types of optical recording media, among a variety of optical recording media, are known. For example, devices that carry out recording or reproducing with either a DVD (Digital Versatile Disk) or a CD (Compact Disk including CD-ROM, CD-R, CD-RW) have been practically used.

For these two optical recording media, the DVD uses visible light having a wavelength of approximately 650 nm for improved recording densities while, by contrast, the CD is required to use near-infrared light having a wavelength of approximately 780 nm because there are some recording media that have no sensitivity to visible light. Accordingly, a single optical pickup device, known as a two-wavelength-type pickup device, uses incident light of these two different wavelengths. The two optical recording media described above require different numerical apertures (NA) due to their different features. For example, the DVD is standardized to use a numerical aperture of about 0.60-0.65 and the CD is standardized to use a numerical aperture in the range of 0.45-0.52. Additionally, the standardized thicknesses of the two types of recording 5 disks, including the thicknesses of the protective layers or substrates made of polycarbonate (PC), are different. For example, the DVD may have a substrate thickness of 0.6 mm and the CD may have a substrate thickness of 1.2 mm.

Because, as described above, the substrate thickness of the optical recording medium is standardized and differs according to the type of optical recording medium used, the amount of 10 spherical aberration introduced by the substrate is different based on the different standardized thicknesses of the substrates of the different recording media. Consequently, for optimum focusing of each of the light beams on the corresponding optical recording medium, it is necessary to optimize the amount of spherical aberration in each light beam at each wavelength for recording and reproducing. This makes it necessary to design the objective lens with different focusing effects according to the light beam and recording medium being used.

Additionally, in response to rapid increases of the data capacity required, the demand for an increase in the recording capacity of recording media has been strong. It is known that the recording capacity of an optical recording medium can be increased by using light of a shorter wavelength and by increasing the numerical aperture (NA) of the objective lens. Concerning a shorter wavelength, the development of a semiconductor laser with a shorter wavelength using a GaN substrate (for example, a semiconductor laser that emits a laser beam of 405 nm wavelength) has advanced to the point where this wavelength is now practical for use.

With the development of short wavelength semiconductor lasers, research and development of AODs (Advanced Optical Disks), also known as HD-DVDs, that provide approximately 20 GB of data storage on a single layer of a single side of an optical disk by using short wavelength light is also progressing. As the AOD standard, the numerical aperture and disk thickness are selected to be about the same as those of DVDs, with the numerical aperture NA and the disk substrate thickness T for an AOD being set at approximately 0.65 and 0.6 mm, respectively.

Furthermore, research and development of Blu-ray disk systems (hereinafter referred to as BD systems) that, similar to AOD systems, use a shorter wavelength of disk illuminating light have progressed, and the standardized values of numerical aperture and disk thickness for these systems are completely different from the corresponding DVD and CD values, with a numerical aperture NA of 0.85 and a disk substrate thickness T of 0.1 mm being standard. Unless otherwise indicated, hereinafter, AODs and BDs collectively will be referred to as “AODs.”

Accordingly, this makes it necessary to design the objective lens with different focusing effects according to the light beam and recording medium being used for AODs, as well as CDs and DVDs, in order to compensate for the amounts of spherical aberration introduced by the different standardized thicknesses of the substrates of the different recording media for light beams at each wavelength for recording and reproducing. By designing the objective lens to have different appropriate focusing effects for light beams of each of the three wavelengths, optimum focusing on each of the three different recording media can be achieved.

Objective optical systems for mounting in optical pickup devices that can be used for three different types of optical recording media, such as AODs, DVDs and CDs as described above, have been proposed. For example, an objective optical system that includes a diffractive optical element with a curved refractive surface and a diffractive surface, and a biconvex lens is described on page 1250 of Extended Abstracts, 50^{th} Japan Society of Applied Physics and Related Societies (March, 2003). The objective optical system described in this publication is designed so that: second-order diffracted light from the diffractive optical element is used for a BD optical recording medium; first-order diffracted light from the diffractive optical element is used for a DVD optical recording medium; and also first-order diffracted light from the diffractive optical element is used for a CD optical recording medium. The spherical aberration that is created by, and varies with, the thickness of the protective layer (i.e., the substrate) of each optical recording medium is corrected by using a diverging light to enter the diffractive optical element. In addition, chromatic aberration is also improved relative to a single component lens by the diffractive optical element having a convergent-type diffractive surface as its front surface (namely, the surface on the light source side), and a concave surface as its rear surface.

In an optical pickup device using three different optical recording media as described above, the optical system should have numerical apertures corresponding to the optical recording media. Therefore, an aperture control structure for controlling the incident beam diameter may be provided on the light source side of the diffractive optical element. For example, an aperture control filter that can change the numerical aperture to 0.5 for a 780 nm CD operating beam, to 0.65 for a 650 nm DVD operating beam, and to 0.85 for a 405 nm BD operating beam may be provided, as described, for example, on pages 19-21 of the 85th Microoptics Workshop, Collected Lecture Drafts (September 2002).

When an aperture control filter is provided, the aperture control filter, diffractive optical element, and objective lens are arranged in this order from the light source side, requiring complex adjustment of intervals and alignment of the elements and, accordingly, making the optical system structure complex. Therefore, a demand for a compact and inexpensive optical system may not be realized.

### BRIEF SUMMARY OF THE INVENTION

The present invention relates to an objective optical system for optical recording media that can efficiently focus each of three light beams on a corresponding one of three optical recording media with different technical standards of the substrate thickness, the wavelengths of the three light beams, and the numerical aperture (NA) of the objective optical system for each of the three light beams, in which a numerical aperture is easily set according to the optical recording medium being used, and excellent optical performance is maintained with a compact and inexpensive objective optical system and optical pickup device using this objective optical system.

### BRIEF DESCRIPTION OF THE DRAWINGS

The present invention will become more fully understood from the detailed description given below and the accompanying drawings, which are given by way of illustration only and thus are not limitative of the present invention, wherein:

FIGS. 1A-1C are schematic diagrams that depict cross-sectional views of the objective optical system for optical recording media of Embodiment 1 of the present invention, with FIG. 1A showing the operation of the objective optical system when used with a first optical recording medium 9a, with FIG. 1B showing the operation of the objective optical system when used with a second optical recording medium 9b, and with FIG. 1C showing the operation of the objective optical system when used with a third optical recording medium 9c;

FIGS. 2A-2C are schematic diagrams that depict cross-sectional views of the objective optical system for optical recording media of Embodiment 2 of the present invention, with FIG. 2A showing the operation of the objective optical system when used with a first optical recording medium 9d, with FIG. 2B showing the operation of the objective optical system when used with a second optical recording medium 9b, and with FIG. 2C showing the operation of the objective optical system when used with a third optical recording medium 9c;

FIGS. 3A-3C are schematic diagrams that depict cross-sectional views of the objective optical system for optical recording media of Embodiment 3 of the present invention, with FIG. 3A showing the operation of the objective optical system when used with a first optical recording medium 9a, with FIG. 3B showing the operation of the objective optical system when used with a second optical recording medium 9b, and with FIG. 3C showing the operation of the objective optical system when used with a third optical recording medium 9c;

FIGS. 4A-4C are schematic diagrams that depict cross-sectional views of the objective optical system for optical recording media of Embodiment 4 of the present invention, with FIG. 4A showing the operation of the objective optical system when used with a first optical recording medium 9d, with FIG. 4B showing the operation of the objective optical system when used with a second optical recording medium 9b, and with FIG. 4C showing the operation of the objective optical system when used with a third optical recording medium 9c;

FIGS. 5A-5C are schematic diagrams that depict cross-sectional views-of the objective optical system for optical recording media of Embodiment 5 of the present invention, with FIG. 5A showing the operation of the objective optical system when used with a first optical recording medium 9d, with FIG. 5B showing the operation of the objective optical system when used with a second optical recording medium 9b, and with FIG. 5C showing the operation of the objective optical system when used with a third optical recording medium 9c;

FIG. 6 is a schematic cross-sectional view of the aperture control coating pattern of the aperture control filter with a diffractive optical function of FIGS. 1A-1C; and

FIG. 7 is a schematic diagram of an optical pickup device using the objective optical system of FIGS. 1A-1C.

### DETAILED DESCRIPTION

The present invention relates to an objective optical system for optical recording media that can be used to focus each of three different light beams of three different wavelengths, λ1, λ2, and λ3, from a light source to a different desired position for each of the first, second and third optical recording media of substrate thicknesses, T1, T2, and T3, respectively, for recording and reproducing information. As herein defined, unless otherwise indicated, the term “light source” refers to the source of the three different light beams of three different wavelengths, whether the light beams originate from a single light emitting source or from separate light emitting sources, such as semiconductor lasers. Additionally, the term “light source” may also include various optical elements, including beamsplitters, mirrors, and converging lenses, which for one or more of the light beams of wavelengths λ1, λ2, and λ3 may operate to provide a collimated light beam or a light beam that is not collimated to be incident on the objective optical system.

The objective optical system includes, in order from the light source side along an optical axis, an aperture control filter with a diffractive optical function and an objective lens of positive refractive power with both surfaces being rotationally symmetric aspheric surfaces. The aperture control filter includes, in a one piece structure, a glass substrate, an aperture control structure on the light source side of the glass substrate, and a diffractive optical structure on the recording media side of the glass substrate that provides the diffractive optical function of the aperture control filter. The diffractive surface is defined by the phase function Φ, and the phase function Φ is chosen so that the objective optical system is able to focus each of the three different light beams of three different wavelengths, λ1, λ2, and λ3, at a different desired position for each of the first, second and third optical recording media of substrate thicknesses, T1, T2, and T3, respectively.

As used herein, the term “diffractive optical structure” refers to any optical structure that operates by diffraction, independent of whether the optical structure also operates, for example, by refraction, absorption, interference and/or polarization properties of light. The diffractive optical structure may be a diffractive element formed directly on the optical recording media side of the glass substrate or a diffractive surface formed on the optical recording media side of the glass substrate itself. In either case, the one piece structures define diffractive optical elements (hereinafter also referred to as DOEs), but in the case of the use of a diffractive element formed on the glass substrate, the separate diffractive element may also be referred to as a DOE formed on a glass substrate as well as the diffractive element and glass substrate together being referred to as a DOE. Preferably, if the diffractive optical structure is formed directly on the optical recording media side of the glass substrate, this is done by molding the diffractive optical structure on the glass substrate so as to adhere to the glass substrate, and preferably plastic is the material molded and adhered to the surface of the glass substrate. The glass substrate may be flat or curved.

Additionally, as used herein, the term “diffractive optical function” refers to diffraction that occurs at a diffractive optical structure, as broadly defined above, that forms part of any optical element, and any such optical element broadly defines a diffractive optical element (DOE). In the present invention, an aperture control filter with a diffractive optical function provides aperture control on the light source side of a glass substrate for setting the numerical aperture to a value corresponding to an optical recording medium to be used with a light beam of a particular wavelength and provides the diffractive optical function on the recording media side of the glass substrate.

The objective optical system is constructed so that light of each wavelength, λ1, λ2, and λ3, diffracted by the aperture control filter with a diffractive optical function is efficiently focused onto the desired position of the corresponding optical recording media of substrate thickness, T1, T2, and T3, respectively. In order for this to occur at all three wavelengths, it is preferable that the diffraction order of the diffracted light of at least one wavelength be different from the diffraction order of the diffracted light of at least one other wavelength.

Additionally, the three wavelengths, the diffraction orders of light used, the numerical apertures NA1, NA2, and NA3 of the objective optical system associated with the wavelengths λ1, λ2, and λ3, respectively, and the substrate thickness of T1, T2, and T3, respectively, of the three recording media are selected so that the numerical aperture of the objective optical system is never larger for light of a larger wavelength being used and so that the substrate thickness is never smaller for light of a larger wavelength being used.

In summary, throughout the following descriptions the following definitions apply:
NA1 is the numerical aperture of the objective optical system for light of the first wavelength λ1 that is focused on the optical recording medium of substrate thickness T1,
NA2 is the numerical aperture of the objective optical system for light of the second wavelength λ2 that is focused on the optical recording medium of substrate thickness T2, and
NA3 is the numerical aperture of the objective optical system for light of the third wavelength λ3 that is focused on the optical recording medium of substrate thickness T3.

Additionally, in the objective optical system of the present invention, the following conditions are satisfied:
λ1<λ2<λ3 Condition (1)
NA1≧NA2>NA3 Condition (2)
T1≦T2<T3 Condition (3).

The aperture control structure on the light source side of the glass substrate helps determine a numerical aperture NA1, NA2, or NA3 corresponding to a particular recording medium having particular substrate thickness T1, T2, T3, respectively, for light of a particular wavelength λ1, λ2, or λ3, respectively.

The objective optical system for the optical recording media and the optical pickup device of the present invention use an aperture control structure on the light source side of a glass substrate and a diffractive optical structure on the optical recording media side of the glass substrate, whereby an aperture control filter and a diffractive optical structure, which are separate members in the prior art, are integrated into a one piece aperture control filter. Separations of and alignments of the various structures are more easily adjusted than in the prior art in which an assembly process where more separations and alignments are required. The optical system of the present invention has a simplified structure, enabling the realization of the required compact and inexpensive optical system.

A plastic substrate may be used to integrate an aperture control filter to include a diffractive optical structure instead of using a glass substrate. However, in practice, when an aperture control coating is applied on a plastic substrate, the aperture control filter is easily deformed and the coating tends to be subject to peeling, wrinkles, or cracks, leading to poor productivity and deteriorated performance. Therefore, a glass substrate should be used to achieve the purposes of the present invention. Using a glass substrate results in increasing the freedom of processing and, further allows for batch processing, thereby reducing costs.

Forming a plastic diffractive optical structure on a glass substrate, as described above, integrates the diffractive optical function with the aperture control filter in a simple and low cost manner with the advantages in productivity described above.

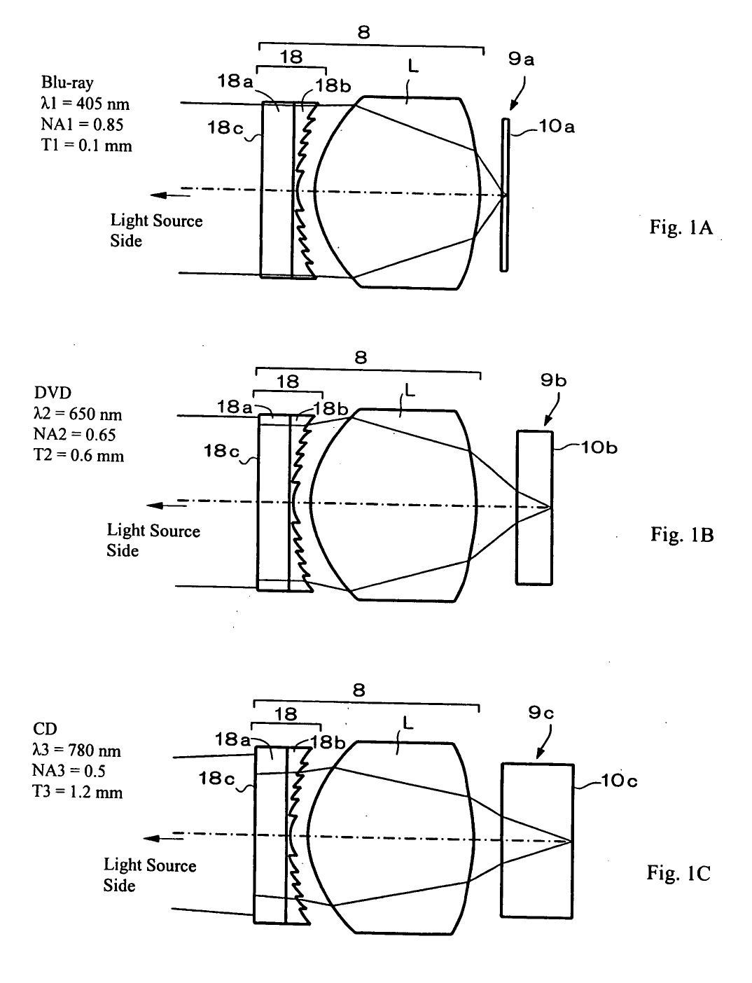

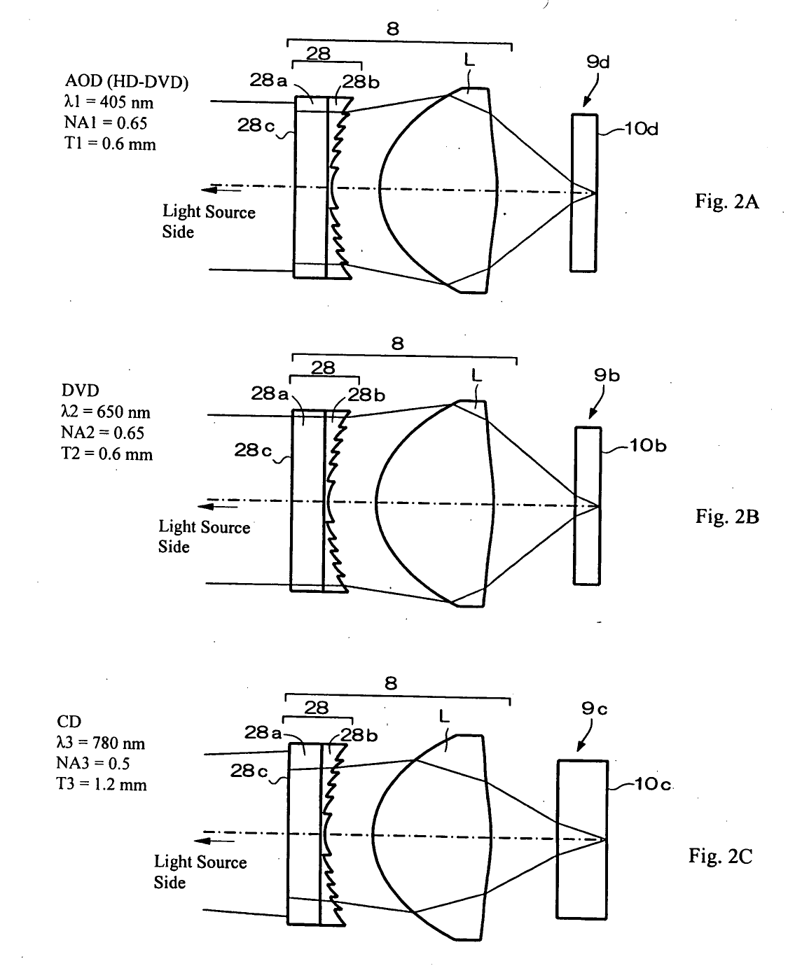

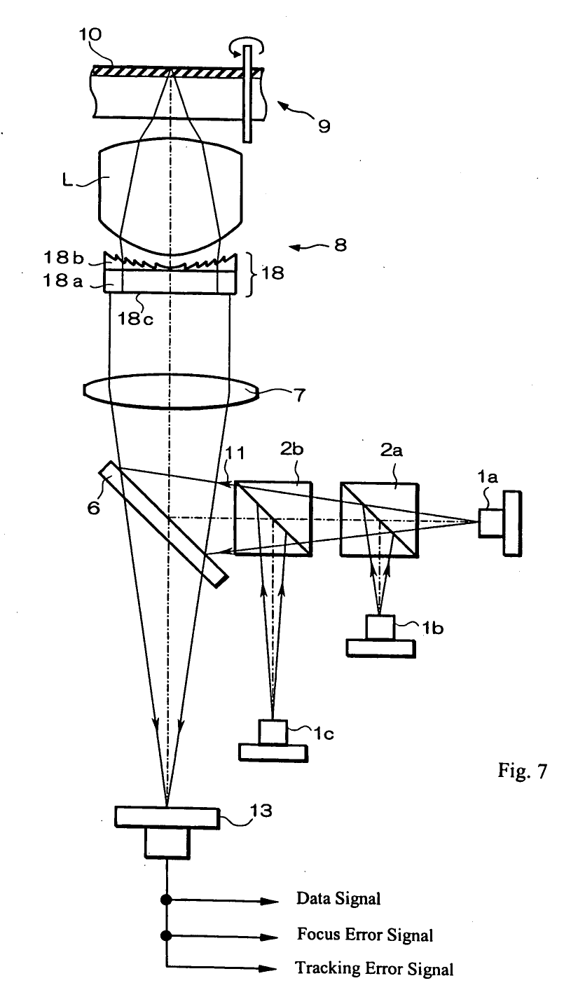

The invention will now be discussed in general terms with reference to FIGS. 1A-1C that show the geometry of the objective optical system for optical recording media of Embodiment 1 of the present invention and FIG. 7 that shows an optical pickup device using the objective optical system for optical recording media of Embodiment 1. In FIGS. 1A-1C and 7, arranged from the light source side, an aperture control filter with a diffractive optical function 18 and an objective lens L having positive refractive power, which constitute an objective optical system 8 for optical recording media, are schematically shown (FIGS. 2A-2C, 3A-3C, 4A-4C, and 5A-5C schematically show Embodiments 2-5, respectively, of objective optical systems that are similar to Embodiment 1). The objective optical system for optical recording media of the present invention is designed to operate with a constant distance between the aperture control filter with a diffractive optical function and the objective lens. In order to prevent FIG. 7 from being too complicated, only one pair of light rays from each light beam are illustrated at every location of the objective optical system in FIG. 7, with only the pair of light rays from semiconductor laser 1a being fully traced and the pairs of rays from semiconductor lasers 1b and 1c being traced only to the cemented surfaces of the prisms 2a and 2b. Additionally, in FIGS. 1A-1C and FIG. 7, a diffractive surface is shown as exaggerated in terms of an actual serrated shape in order to more clearly show the diffractive nature of the surface.

As shown in FIG. 7, a laser beam 11 that is emitted from one of the semiconductor lasers 1a, 1b, and 1c is reflected by a half mirror 6, is refracted by a collimator lens 7 having positive refractive power, and is focused by the objective optical system 8 onto a recording area 10 of an optical recording medium 9. Although lens 7 is described as a collimator lens, it is noted that lens 7 may not collimate the light beams of all three wavelengths, but may, for example, as described in more detail below, and as shown, for example, in FIG. 1C for Embodiment 1 of the present invention, provide a diverging light beam to an aperture control filter with a diffractive optical function 18. The laser beam 11 is converted to a convergent beam by the objective optical system 8 so that it is focused onto the recording region 10 of the optical recording medium 9.

More specifically, as shown in FIGS. 1A-1C, the arrangement includes an optical recording medium 9a that is a BD with a substrate thickness T1 of 0.1 mm used with a light beam of wavelength λ1 that is equal to 405 nm and with a numerical aperture NA1 of 0.85 (FIG. 1A), an optical recording medium 9b that is a DVD with a substrate thickness T2 of 0.6 mm used with a light beam of wavelength λ2 that is equal to 650 nm and with a numerical aperture NA2 of 0.65 (FIG. 1B), and an optical recording medium 9c that is a CD with a substrate thickness T3 of 1.2 mm used with a light beam of wavelength λ3 that is equal to 780 nm and with a numerical aperture NA3 of 0.50 (FIG. 1C).

The semiconductor laser 1a emits the visible laser beam having the wavelength of approximately 405 nm (λ1) for BDs. The semiconductor laser 1b emits the visible laser beam having the wavelength of approximately 650 nm (λ2) for DVDs. The semiconductor laser 1c emits the near-infrared laser beam having the wavelength of approximately 780 nm (λ3) for CDs such as CD-R (recordable optical recording media) (hereinafter the term CD generally represents CDs of all types).

The arrangement of FIG. 7 does not preclude semiconductor lasers 1a-1c providing simultaneous outputs. However, it is preferable that the lasers be used alternately depending on whether the optical recording media 9 of FIG. 7 used is specifically, as shown in FIGS. 1A-1C, a BD 9a, a DVD 9b, or a CD 9c. As shown in FIG. 7, the laser beam output from the semiconductor lasers 1a, 1b irradiates the half mirror 6 by way of prisms 2a, 2b, and the laser beam output from the semiconductor laser 1c irradiates the half mirror 6 by way of the prism 2b.

The collimator lens 7 is schematically shown in FIG. 7 as a single lens element. However, it may be desirable to use a collimator lens made up of more than one lens element in order to better correct chromatic aberration of the collimator lens 7.

In the optical pickup device of the present invention, each of the optical recording media 9, as shown in FIG. 7, whether a BD 9a, a DVD 9b or a CD 9c shown in FIGS. 1A-1C, respectively, must be arranged at a predetermined position along the optical axis, for example, on a turntable, so that the recording region 10 of FIG. 7 (one of recording regions 10a, 10b, and 10c of a BD 9a, a DVD 9b and a CD 9c of FIGS. 1A-1C, respectively) is positioned at the focus of the light beam of the corresponding wavelength (λ1, λ2, and λ3 for recording regions 10a, 10b, and 10c, respectively) in order to properly record signals and reproduce recorded signals.

In the recording region 10, pits (not necessarily of recessed form) carrying signal information are arranged in tracks. The reflected light of a laser beam 11 is made incident onto the half mirror 6 by way of the objective optical system 8 and the collimator lens 7 while carrying the signal information, and the reflected light is transmitted through the half mirror 6. The transmitted light is then incident on a four-part photodiode 13. The respective quantities of light received at each of the four parts of the four-part photodiode 13 are converted to electrical signals that are operated on by calculating circuits (not shown in the drawings) in order to obtain data signals and respective error signals for focusing and tracking.

Because the half mirror 6 is inserted into the optical path of the return light from the optical recording media 9 at a forty-five degree angle to the optical axis, the half mirror 6 introduces astigmatism into the light beam, as a cylindrical lens may introduce astigmatism, whereby the amount of focusing error may be determined according to the form of the beam spot of the return light on the four-part photodiode 13. Also, a grating may be inserted between the semiconductor lasers 1a-1c and the half mirror 6 so that tracking errors can be detected using three beams.

As shown in FIGS. 1A-1C and FIG. 7, the objective optical system 8 of the present invention includes, in order from the light source side, an aperture control filter with a diffractive optical function 18 and an objective lens L having positive refractive power. The aperture control filter with a diffractive optical function 18 has an aperture control coating part 18c on the light source side of a glass plate 18a and a diffractive optical element part 18b on the optical recording media side of the glass plate 18a. As discussed above, in the present invention, an aperture control filter and a diffractive optical structure, which are separate members in the prior art, are integrated into a one piece aperture control filter so that separations of and alignments of the various structures are more easily adjusted than in the prior art where an assembly process with more separations and alignments is required; thus the optical system of the present invention has a simplified structure, enabling the realization of the required compact and inexpensive optical system.

Forming the substrate of the aperture control filter with a diffractive optical function 18 as a glass plate 18a prevents the element from being easily deformed or the coating from being subject to peeling, wrinkles, or cracks, which are likely to occur with a plastic substrate, thereby improving productivity and product quality. In fact, the present inventors have attempted to use a plastic substrate as the substrate of an aperture control filter with a diffractive optical function and have conclusively found that it is very difficult to eliminate the problems noted above with the use of a plastic substrate.

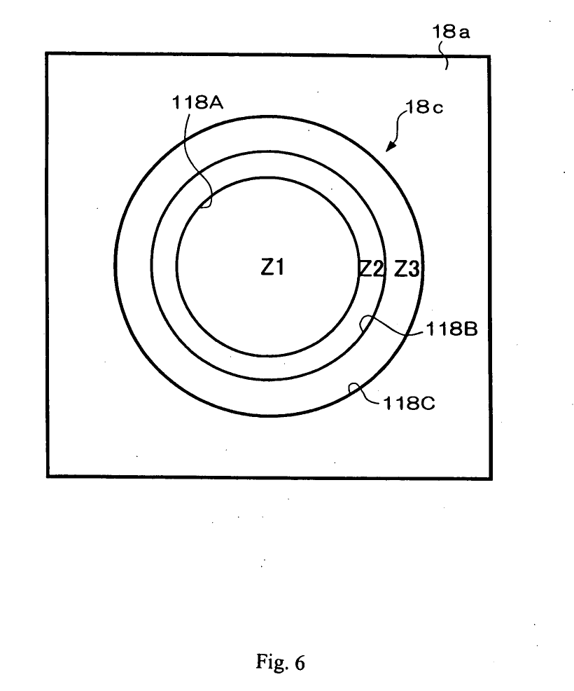

The aperture control coating part 18c forms an aperture control structure on the light source side of the aperture control filter. The aperture control coating part 18c consists of, for example, three concentric dichroic films, as shown in FIG. 6. Among them, the smallest circle 118A corresponds to the area for the NA of 0.50, the second smallest circle 118B to the area for the NA of 0.65, and the largest circle 118C to the area for the NA of 0.85. The zone enclosed by the smallest circle 118A (Zone Z1) has a dichroic coating that transmits an operating wavelength of 405 nm for the BD 9a, an operating wavelength of 650 nm for the DVD 9b, and an operating wavelength of 780 nm for the CD 9c. The zone between the smallest circle 118A and the second smallest circle 118B (Zone Z2) has a dichroic coating that transmits an operating wavelength of 405 nm for the BD 9a and an operating wavelength of 650 nm for the DVD 9b and reflects an operating wavelength of 780 nm for the CD 9c. The zone between the second smallest circle 118B and the largest circle 118C (Zone Z3) has a dichroic coating that transmits an operation wavelength of 405 nm for the BD 9a and reflects an operating wavelength of 650 nm for the DVD 9b and an operating wavelength of 780 nm for the CD 9c. In this way, the laser beam entering the objective optical system 8 is adjusted for a beam diameter corresponding to an adequate NA for the recording medium 9.

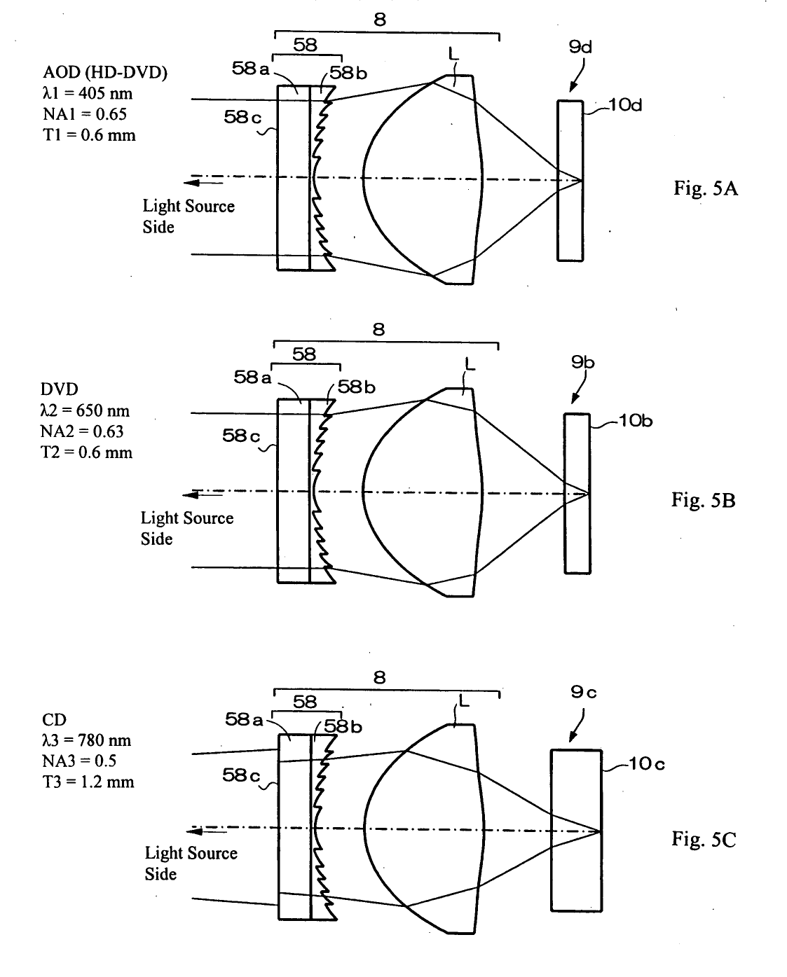

When, as shown in FIG. 5A, an AOD 9d (numerical aperture NA=0.65, operating wavelength λ1=405 nm, and substrate thickness T1=0.6 mm) is used instead of the BD 9a, the aperture control coating part 18c is constructed as follows.

In such a case, among the three concentric circles shown in FIG. 6, the largest circle 118C can overlap with the second smallest circle 118B. Therefore, the smallest circle 118A corresponds to an area for the NA of 0.50 and the second smallest circle 118B (coinciding with the largest circle 118C) corresponds to the area for the NA of 0.65 (for the AOD) or approximately to the NA of 0.63 (for the DVD). The zone enclosed by the smallest circle 118A (Zone Z1) has a dichroic coating that transmits an operating wavelength of 405 nm for the AOD 9d, an operating wavelength of 650 nm for the DVD 9b, and an operating wavelength of 780 nm for the CD 9c. The zone between the smallest circle 118A and the second smallest circle 118B (coinciding with the largest circle 118C) (Zone Z2—there is no Zone Z3) has a dichroic coating that transmits an operating wavelength of 405 nm for the AOD 9d and an operating wavelength of 650 nm for the DVD 9b and that reflects an operating wavelength of 780 nm for the CD 9c.

Referring again to FIGS. 1A-1C and FIG. 7, the diffractive optical element part 18b is made of an ultraviolet curing plastic. The diffractive optical element part 18b is produced by placing an ultraviolet curing plastic on a glass plate 18a, pressing the ultraviolet curing plastic using a metal mold for the DOE to transfer the DOE shape onto the ultraviolet curing plastic, and then illuminating the ultraviolet curing plastic with ultraviolet light. In this way, the diffractive optical element part 18b is adhered to and integrated with the glass plate 18a. This formation of an ultraviolet curing plastic adhered to the glass plate 18a enables the diffractive optical element part 18b to be integrated with the glass plate 18a in a simple and low cost manner, with the glass plate 18a being used for the benefit of the aperture control coating part 18c (which otherwise would suffer deformation of the element and peeling, wrinkling, or cracking of the coating, thus leading to poor productivity and deteriorated performance, as described above).

It is preferable that the diffractive optical surface have a shape so that it diffracts light of the first wavelength λ1 with maximum intensity in a second-order diffracted beam, diffracts light of the second wavelength 2 with maximum intensity in a first-order diffracted beam, and diffracts light of the third wavelength λ3 with maximum intensity in a first-order diffracted beam. By selecting the diffraction orders in this manner, the diffraction grooves of the diffractive optical surface can be made shallow, and all three light beams can be converged with high diffraction efficiency without applying an excessive burden on metal mold processing and/or the shaping of the refractive surfaces.

For example, in the objective optical system 8 for optical recording media according to Embodiments 1 to 5 described later, the diffractive optical element part 18b, 28b, 38b, 48b, or 58b are constructed in a manner so as to maximize the quantity of second-order diffracted light for a light beam of wavelength 405 nm (λ1) corresponding to the BD 9a or the AOD 9d, so as to maximize the quantity of first-order diffracted light for a light beam of wavelength 650 nm (λ2) corresponding to the DVD 9b, and so as to maximize the quantity of first-order diffracted light for a light beam of 780 nm (λ3) corresponding to the CD 9c.

It is preferable that the diffractive optical element part 18b of the objective optical system 8 of the present invention be formed as a diffractive structure on a ‘virtual plane’, herein defined as meaning that the surface where the diffractive structure is formed would be planar but for the diffractive structures of the diffractive surface, and that the virtual plane be perpendicular to the optical axis. Preferably, the cross-sectional configuration of the diffractive surface is serrated so as to define a so-called kinoform. FIGS. 1A-1C and FIG. 7 exaggerate the actual size of the serrations of the diffractive surface.

The diffractive surface adds a difference in optical path length equal to m·λ·Φ/(2π) to the diffracted light, where λ is the wavelength, Φ is the phase function of the diffractive optical surface, and m is the order of the diffracted light that is focused on a recording medium 9. The phase function Φ is given by the following equation:
Φ=ΣWᵢ·Y²ⁱ Equation (A)
where

Y is the distance in mm from the optical axis; and

Wᵢ is a phase function coefficient, and the summation extends over i.

The specific heights of the serrated steps of the diffractive surface of the diffractive optical element part 18b are based on ratios of diffracted light of each order for the light beams of different wavelengths λ1, λ2, and λ3. Additionally, it is essential that the diffractive optical element part 18b be positioned concentrically with the concentric pattern described above for the aperture control coating part 18c. In addition, the diffractive optical element part 18b must be on the same optical axis as the objective lens L with high accuracy.

All the DOEs in the objective optical systems according to Embodiments 1 to 5 are depicted in an exaggerated form in FIGS. 1A to 5C and FIG. 7 as compared to the actual forms of the DOEs.

The objective lens L of the objective optical system for optical recording media of the present invention preferably includes at least one aspheric surface. It is also preferable that the 20 aspheric surfaces of the objective optical system 8 of the present invention be rotationally symmetric aspheric surfaces defined using the following aspheric equation in order to improve aberration correction for all of the recording media 9a, 9b, and 9c, or all of the recording media 9b, 9c, and 9d (i.e., or all of the recording media being used), in order to assure proper focusing during both recording and reproducing operations:
Z=[(C·Y²)/{1+(1−K·C²·Y²)^{1/2}}]+ΣAᵢ·Y²ⁱ Equation (B)
where

Z is the length (in mm) of a line drawn from a point on the aspheric lens surface at a distance Y from the optical axis to the tangential plane of the aspheric surface vertex,

C is the curvature (=1/the radius of curvature, R in mm) of the aspheric lens surface on the optical axis,

Y is the distance (in mm) from the optical axis,

K is the eccentricity, and

Aᵢ is an aspheric coefficient, and the summation extends over i.

It is preferable that the diffractive surface formed on the diffractive optical element part 18b and the rotationally symmetric aspheric surface formed on the objective lens L are determined to focus each of the three beams of light with the three wavelengths, λ1, λ2, and λ3, on a corresponding recording region 10, as shown in FIG. 7 (10a, 10b, 10c, as shown in FIGS. 1A-1C, respectively) with excellent correction of aberrations.

The objective lens L that forms a component of the present invention may be made of plastic. Plastic materials are advantageous in reducing manufacturing costs and making manufacturing easier, and in making the system lighter, which may assist in high speed recording and replaying. In particular, using a mold makes manufacture of the objective lens much easier than many other processes of manufacturing.

Alternatively, the objective lens L that forms a component of the present invention may be made of glass. Glass is advantageous for several reasons: it generally has optical properties that vary less with changing temperature and humidity than for plastic; and appropriate glass types are readily available for which the light transmittance decreases less than for plastic with prolonged use, even at relatively short wavelengths. Whether made of glass or plastic, the objective lens that forms a component of the present invention is conventional, and will not be discussed in further detail. Such objective lenses meeting the design criteria mentioned above can be readily obtained. As an example, such objective lenses can be ordered from Sumita Optical Co., Japan (Internet address: http://www.sumita-opt.cojp/)

Five embodiments of the objective optical system for optical recording media of the present invention will now be set forth in detail.

### Embodiment 1

FIGS. 1A-1C are schematic diagrams that depict cross-sectional views of the objective optical system for optical recording media of Embodiment 1 of the present invention, with FIG. 1A showing the operation of the objective optical system when used with a first optical recording medium 9a, with FIG. 1B showing the operation of the objective optical system when used with a second optical recording medium 9b, and with FIG. 1C showing the operation of the objective optical system when used with a third optical recording medium 9c. As shown in FIGS. 1A-1C, the objective optical system of the present invention includes, in order from the light source side, an aperture control filter 18 with a diffractive optical function and an objective lens L. As shown in FIGS. 1A-1C, a constant distance is maintained between the aperture control filter 18 with a diffractive optical function and the objective lens L when different wavelengths and recording media are used. The aperture control filter 18 with a diffractive optical function has an aperture control coating part 18c formed by a dichroic film on the light source side surface of a glass plate 18a and a diffractive optical element part 18b on the optical recording media side surface of the glass plate 18a. The diffractive optical element part 18b also has negative refractive power as a whole. On the other hand, the objective lens L is a biconvex lens, which has positive refractive power, with each of the light source side surface and the optical recording media side surface being an aspheric surface of revolution.

In the objective optical system 8 for optical recording media of Embodiment 1, an operating beam enters the aperture control coating part 18c as a collimated beam when one of the BD 9a and DVD 9b is selected as the optical recording medium 9. On the other hand, an operating beam enters the aperture control coating part 18c as a diverging beam when the CD 9c is selected as the optical recording medium 9.

The diffractive surfaces of the diffractive optical element parts 18b, 28b, 38b, 48b, and 58b and the aspheric surfaces of revolution of the objective lenses L are defined for all embodiments by the phase function equation (Equation (A)) and the aspheric equation (Equation (B)) given above. The diffractive optical surfaces of the diffractive optical element parts 18b, 28b, 38b, 48b, and 58b (that correspond to Embodiments 1-5, respectively) are each formed with a cross-sectional configuration of concentric serrations that define a grating.

In Embodiment 1, the objective optical system 8 sets the numerical aperture to a specific value: numerical aperture NA1=0.85 for the BD 9a using an operating beam wavelength of λ1=405 nm; numerical aperture NA2=0.65 for the DVD 9b using an operating wavelength of λ2=650 nm; and numerical aperture NA3=0.50 for the CD 9c using an operating wavelength of λ3=780 nm. As shown in FIGS. 1A-1C, this arrangement results in the beams having controlled beam diameters for successful focusing on the BD 9a, DVD 9b, or CD 9c at the recording area 10a, 10b, or 10c, respectively.

In Embodiment 1, as well as in Embodiments 2-5 described below, only one operating beam is selected according to the optical recording medium 9 selected.

### Embodiment 2

FIGS. 2A-2C are schematic diagrams that depict cross-sectional views of the objective optical system for optical recording media of Embodiment 2 of the present invention, with FIG. 2A showing the operation of the objective optical system when used with a first optical recording medium 9d, with FIG. 2B showing the operation of the objective optical system when used with a second optical recording medium 9b, and with FIG. 2C showing the operation of the objective optical system when used with a third optical recording medium 9c. As shown in FIGS. 2A-2C, the objective optical system of the present invention includes, in order from the light source side, an aperture control filter 28 with a diffractive optical function and an objective lens L. As shown in FIGS. 2A-2C, a constant distance is maintained between the aperture control filter 28 with a diffractive optical function and the objective lens L when different wavelengths and recording media are used. The aperture control filter 28 with a diffractive optical function has an aperture control coating part 28c formed by a dichroic film on the light source side surface of a glass plate 28a and a diffractive optical element part 28b on the optical recording media side surface of the glass plate 28a. The diffractive optical element part 28b also has negative refractive power as a whole. On the other hand, the objective lens L is a biconvex lens, which has positive refractive power, with both the light source side surface and the optical recording media side surface being an aspheric surface of revolution.

In Embodiment 2, the objective optical system 8 sets the numerical aperture to a specific value: numerical aperture NA1=NA2=0.65 for the AOD 9d and DVD 9b using an operating beam wavelengths of λ1=405 nm and λ2=650 nm, respectively, and numerical aperture NA3=0.50 for the CD 9c using an operating wavelength of λ3=780 nm. As shown in FIGS. 2A-2C, this arrangement results in the beams having controlled beam diameters for successful focusing on the AOD 9d, the DVD 9b, or the CD 9c at the recording area 10d, 10b, or 10c, respectively.

In the objective optical system 8 for optical recording media of Embodiment 2, an operating beam enters the aperture control coating part 28c as a collimated beam when one of the AOD 9d and the DVD 9b is selected as-the optical recording medium 9. On the other hand, an operating beam enters the aperture control coating part 28c as a diverging beam when the CD 9c is selected as the optical recording medium 9.

### Embodiment 3

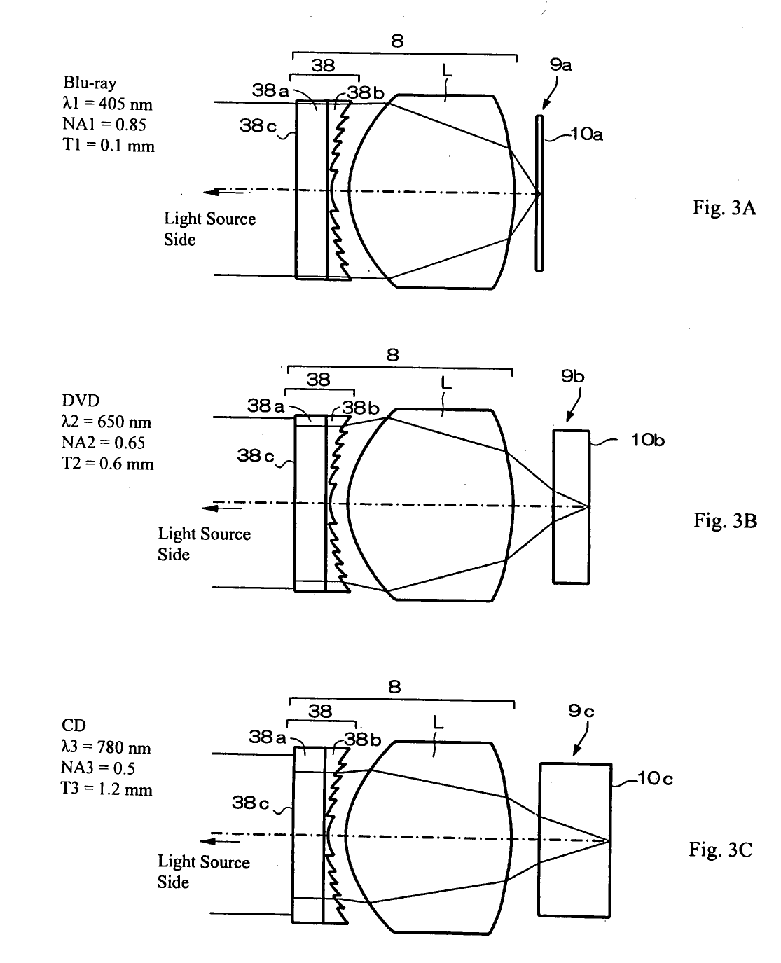

FIGS. 3A-3C are schematic diagrams that depict cross-sectional views of the objective optical system for optical recording media of Embodiment 3 of the present invention, with FIG. 3A showing the operation of the objective optical system when used with a first optical recording medium 9a, with FIG. 3B showing the operation of the objective optical system when used with a second optical recording medium 9b, and with FIG. 3C showing the operation of the objective optical system when used with a third optical recording medium 9c. As shown in FIGS. 3A-3C, the objective optical system of the present invention includes, in order from the light source side, an aperture control filter 38 with a diffractive optical function and an objective lens L. As shown in FIGS. 3A-3C, a constant distance is maintained between the aperture control filter 38 with a diffractive optical function and the objective lens L when different wavelengths and recording media are used. The aperture control filter 38 with a diffractive optical function has an aperture control coating part 38c formed by a dichroic film on the light source side surface of a glass plate 38a and a diffractive optical element part 38b on the optical recording media side surface of the glass plate 38a. The diffractive optical element part 38b also has negative refractive power as a whole. On the other hand, the objective lens L is a biconvex lens, which has positive refractive power, with both the light source side surface and the optical recording media side surface being an aspheric surface of revolution.

In Embodiment 3, the objective optical system 8 sets the numerical aperture to a specific value: numerical aperture NA1=0.85 for the BD 9a using an operating beam wavelength of λ1=405 nm; numerical aperture NA2=0.65 for the DVD 9b using an operating wavelength of λ2=650 nm; and numerical aperture NA3=0.50 for the CD 9c using an operating wavelength of λ3=780 nm. As shown in FIGS. 3A-3C, this arrangement results in the beams having controlled beam diameters for successful focusing on the BD 9a, the DVD 9b, or the CD 9c at the recording area 10a, 10b, or 10c, respectively.

In the objective optical system 8 for optical recording media of Embodiment 3, an operating beam enters the aperture control coating part 38c as a collimated beam when any one of the BD 9a, the DVD 9b, or the CD 9c is selected as the optical recording medium 9.

### Embodiment 4

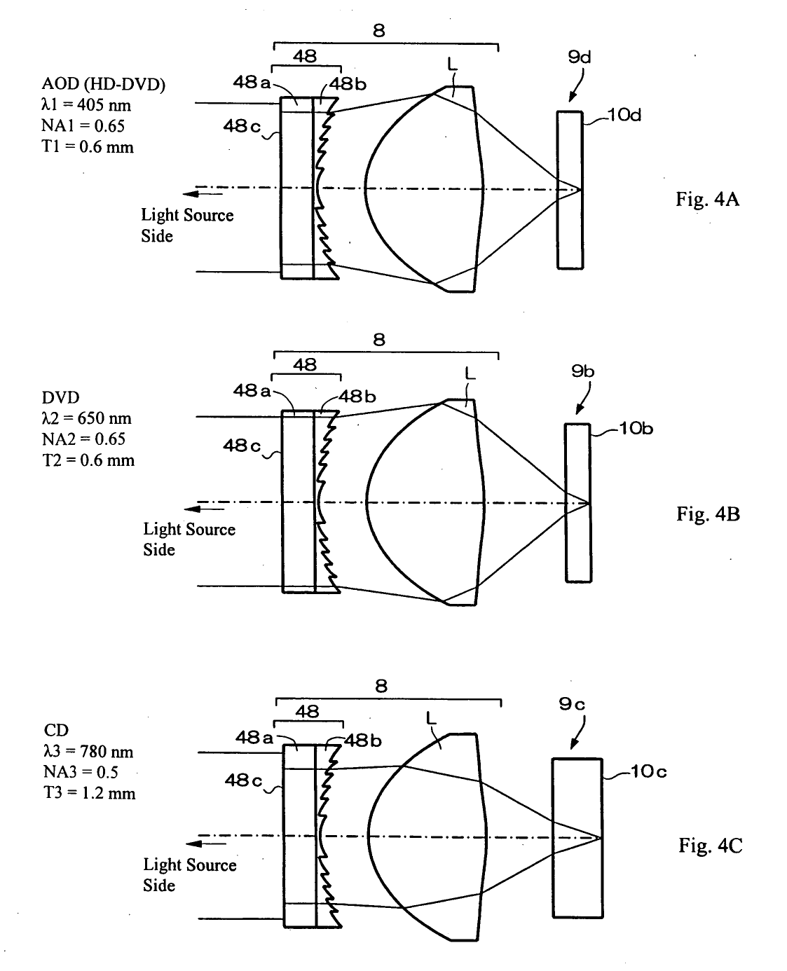

FIGS. 4A-4C are schematic diagrams that depict cross-sectional views of the objective optical system for optical recording media of Embodiment 4 of the present invention, with FIG. 4A showing the operation of the objective optical system when used with a first optical recording medium 9d, with FIG. 4B showing the operation of the objective optical system when used with a second optical recording medium 9b, and with FIG. 4C showing the operation of the objective optical system when used with a third optical recording medium 9c. As shown in FIGS. 4A-4C, the objective optical system of the present invention includes, in order from the light source side, an aperture control filter 48 with a diffractive optical function and an objective lens L. As shown in FIGS. 4A-4C, a constant distance is maintained between the aperture control filter 48 with a diffractive optical function and the objective lens L when different wavelengths and recording media are used. The aperture control filter 48 with a diffractive optical function has an aperture control coating part 48c formed by a dichroic film on the light source side surface of a glass plate 48a and a diffractive optical element part 48b on the optical recording media side surface of the glass plate 48a. The diffractive optical element part 48b also has negative refractive power as a whole. On the other hand, the objective lens L is a biconvex lens, which has positive refractive power, with both the light source side surface and the optical recording media side surface being an aspheric surface of revolution.

In Embodiment 4, the objective optical system 8 sets the numerical aperture to a specific value: numerical aperture NA1=NA2=0.65 for the AOD 9d and DVD 9b using an operating beam wavelengths of λ1=405 nm and λ2=650 nm, respectively, and numerical aperture NA3=0.50 for the CD 9c using an operating wavelength of λ3=780 nm. As shown in FIGS. 4A-4C, this arrangement results in the beams having controlled beam diameters for successful focusing on the AOD 9d, the DVD 9b, or the CD 9c at the recording area 10d, 10b, or 10c, respectively.

In the objective optical system 8 for optical recording media of Embodiment 4, an operating beam enters the aperture control coating part 48c. as a collimated beam when any one of the AOD 9d, the DVD 9b, or the CD 9c is selected as the optical recording medium 9.

### Embodiment 5

FIGS. 5A-5C are schematic diagrams that depict cross-sectional views of the objective optical system for optical recording media of Embodiment 5 of the present invention, with FIG. 5A showing the operation of the objective optical system when used with a first optical recording medium 9d, with FIG. 5B showing the operation of the objective optical system when used with a second optical recording medium 9b, and with FIG. 5C showing the operation of the objective optical system when used with a third optical recording medium 9c. As shown in FIGS. 5A-5C, the objective optical system of the present invention includes, in order from the light source side, an aperture control filter 58 with a diffractive optical function and an objective lens L. As shown in FIGS. 5A-5C, a constant distance is maintained between the aperture control filter 58 with a diffractive optical function and the objective lens L when different wavelengths and recording media are used. The aperture control filter 58 with a diffractive optical function has an aperture control coating part 58c formed by a dichroic film on the light source side surface of a glass plate 58a and a diffractive optical element part 58b on the optical recording media side surface of the glass plate 58a. The diffractive optical element part 58b also has negative refractive power as a whole. On the other hand, the objective lens L is a biconvex lens, which has positive refractive power, with both the light source side surface and the optical recording media side surface being an aspheric surface of revolution.

In Embodiment 5, the objective optical system 8 sets the numerical aperture to a specific value: numerical aperture NA1=0.65 for the AOD 9d using an operating beam wavelength of λ1=405 nm; numerical aperture NA2=0.63 for the DVD 9b using an operating wavelength of λ2=650 nm; and numerical aperture NA3=0.50 for the CD 9c using an operating wavelength of λ3=780 nm. As shown in FIGS. 5A-5C, this arrangement results in the beams having controlled beam diameters for successful focusing on the AOD 9d, the DVD 9b, or the CD 9c at the recording area 10d, 10b, or 10c, respectively. In Embodiment 5, as NA1=0.65 for the AOD 9d and NA2=0.63 for the DVD 9b, their incident beams have equal diameters.

In the objective optical system 8 for optical recording media of Embodiment 5, an operating beam enters the aperture control coating part 58c as a collimated beam when one of the AOD 9d and the DVD 9b is selected as the optical recording medium 9. On the other hand, an operating beam enters the aperture control coating part 58c as a diverging beam when the CD 9c is selected as the optical recording medium 9.

The objective optical system for optical recording media of the present invention being thus described, it will be obvious that it may be varied in many ways. Similarly, it is obvious that the optical pickup device using the objective optical system for optical recording media of the present invention may be modified in various ways.

The objective optical system for optical recording media of the present invention can have a diffractive optical function directly formed on a glass substrate. In such a case, it is preferable that the diffractive optical function is formed by molding on the optical recording media side surface of a glass substrate.

As described above, the objective optical system consists of two optical elements, an aperture control filter with a diffractive optical function and an objective lens. Therefore, when one of the optical elements is slanted, coma aberration resulting from a slanted optical recording media can be successfully corrected.

The diffractive optical function of the present invention is intended to be constructed in the manner that the diffracted lights of the specific orders of diffraction appear in the largest amount, with the ideal being one hundred percent diffracted light of the diffractive order of the light being used. Additionally, the structures of the diffractive surface are not confined to ones having serrated cross-sections. For example, diffractive surfaces having stepped cross-sections can be used.

Additionally, although the diffractive optical elements of the embodiments described above also have negative refractive power overall, the diffractive optical elements can have positive refractive power depending on other factors, such as the optical powers of other optical elements of the objective optical system.

Also, the objective lens of the objective optical system is not confined to one having a rotationally symmetric aspheric surface both on the light source side and on the optical recording media side as in the embodiments described above, but the objective lens may include flat, spherical, or a single aspheric surface as appropriate.

Furthermore, the optical recording media in the objective optical system for optical recording media and the optical pickup device of the present invention are not confined to a combination of a BD (or an AOD), a DVD, and a CD. Rather, the present invention can be applied where optical recording media satisfying Conditions (1)-(3) above are used for recording/reproducing in a single optical pickup device.

Additionally, when the optical recording media are a BD (or an AOD), a DVD, and a CD as in the embodiments above, the operating beam wavelengths are not confined to those in the embodiments above. Beams having other wavelengths than 405 nm for the BD and the AOD, 650 nm for the DVD, and 780 nm for the CD can be used if they meet optical recording media standards and are selected within the standard ranges. The same is true for the numerical aperture and substrate thicknesses.

Other optical recording media using, for example, shorter wavelengths as the operating beam wavelengths may be developed in future. The present invention can be applied to such a case. Then, it is preferable that the lens is made of a material exhibiting an excellent transmittance for the operating wavelengths being used. For example, the glass substrate of the objective optical system for optical recording media of the present invention may be made of fluorite or quartz.

Additionally, the objective optical system for the optical recording media of the present invention can obviously be also applied to four or more optical recording media.

Also, although the optical pickup devices described above use three light sources emitting light of three different wavelengths, a single light source emitting two light beams having different wavelengths through adjacent openings can be used. In such a case, a single prism, for example, can be used instead of the prisms 2a and 2b shown in FIG. 7. Furthermore, one light source emitting three beams having different wavelengths through adjacent openings can be used. In such a case, the prisms 2a and 2b shown in FIG. 7, for example, are unnecessary.

Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. An objective optical system for focusing light from a light source onto optical recording media, the objective optical system comprising, in order from the light source side along an optical axis:
an aperture control filter with a diffractive optical function; and
an objective lens;
wherein
the aperture control filter includes, in a one piece structure, a glass substrate, an aperture control structure on the light source side of the glass substrate, and a diffractive optical structure on the recording media side of the glass substrate that provides the diffractive optical function of the aperture control filter;
the objective optical system is configured to receive a light beam of a first wavelength λ1 from its light source side and focus diffracted light diffracted by said diffractive optical structure at a first numerical aperture NA1 onto a desired portion of a first optical recording medium having a substrate thickness T1, to receive a light beam of a second wavelength λ2 from its light source side and focus diffracted light diffracted by said diffractive optical structure at a second numerical aperture NA2 onto a desired portion of a second optical recording medium having a substrate thickness T2, and to receive a light beam of a third wavelength λ3 from its light source side and focus diffracted light diffracted by said diffractive optical structure at a third numerical aperture NA3 onto a desired portion of a third optical recording medium having a substrate thickness T3; and
the following conditions are satisfied:
λ1<λ2<λ3
NA1≦NA2>NA3
T1≦T2<T3.

2. The objective optical system according to claim 1, wherein the diffractive optical structure is a plastic structure that is adhered onto the glass substrate.

3. The objective optical system according to claim 1, wherein said objective lens includes at least one aspheric surface.

4. The objective optical system according to claim 2, wherein said objective lens includes at least one aspheric surface.

5. The objective optical system of claim 1, wherein:
the first optical recording medium is an advanced optical disk;
the second optical recording medium is a DVD; and
the third optical recording medium is a CD.

6. The objective optical system of claim 2, wherein:
the first optical recording medium is an advanced optical disk;
the second optical recording medium is a DVD; and
the third optical recording medium is a CD.

7. The objective optical system of claim 3, wherein:
the first optical recording medium is an advanced optical disk;
the second optical recording medium is a DVD; and
the third optical recording medium is a CD.

8. The objective optical system of claim 4, wherein:
the first optical recording medium is an advanced optical disk;
the second optical recording medium is a DVD; and
the third optical recording medium is a CD.

9. The objective optical system of claim 1, wherein:
the first optical recording medium is a Blu-ray disk;
the second optical recording medium is a DVD; and
the third optical recording medium is a CD.

10. The objective optical system of claim 2, wherein:
the first optical recording medium is a Blu-ray disk;
the second optical recording medium is a DVD; and
the third optical recording medium is a CD.

11. The objective optical system of claim 3, wherein:
the first optical recording medium is a Blu-ray disk;
the second optical recording medium is a DVD; and
the third optical recording medium is a CD.

12. The objective optical system of claim 4, wherein:
the first optical recording medium is a Blu-ray disk;
the second optical recording medium is a DVD; and
the third optical recording medium is a CD.

13. An optical pickup device that includes the objective optical system according to claim 1.

14. An optical pickup device that includes the objective optical system according to claim 2.

15. An optical pickup device that includes the objective optical system according to claim 3.

16. An optical pickup device that includes the objective optical system according to claim 4.

17. An optical pickup device that includes the objective optical system according to claim 5.

18. An optical pickup device that includes the objective optical system according to claim 6.

19. An optical pickup device that includes the objective optical system according to claim 9.

20. An optical pickup device that includes the objective optical system according to claim 10.
